(19) United States
(12) Patent Application Publication
(10) Pub. No.: US 2024/0245068 A1
(43) Pub. Date: Jul. 25, 2024

(54) PROCESS TO PRODUCE A LONG-LIFE, HIGH-PROTEIN, FERMENTED DAIRY PRODUCT AND THE RESULTING PRODUCT

(71) Applicant: FrieslandCampina Nederland B.V., Amersfoort (NL)

(72) Inventor: Berthold KNOCHE, Heilbronn (DE)

(73) Assignee: FrieslandCampina Nederland B.V., Amersfoort (NL)

(21) Appl. No.: 18/398,726

(22) Filed: Dec. 28, 2023

Related U.S. Application Data
(63) Continuation of application No. PCT/EP22/67678, filed on Jun. 28, 2022.

(30) Foreign Application Priority Data
Jun. 29, 2021 (EP) 21182509.6

(51) Int. Cl. A23C 9/137; A23C 9/123; A23C 9/13; A23C 21/02

(52) U.S. Cl. CPC A23C 9/137; A23C 9/123; A23C 9/1307; A23C 21/02

(57) ABSTRACT

The present invention pertains to a long-life, high-protein, fermented dairy product comprising a total amount of protein of between 6 and 24% by weight, based on the total weight of the product; with a total amount of micellar casein in the range of 15 and 40% w/w, based on the total amount of protein, and a total amount of 25 and 75% w/w of microparticulated whey protein, based on the total amount of protein; further comprising between 0.3 and 4% by weight of two or more stabilizers selected from the group consisting of starch, gelatin, low-ester amidated pectin, guar, gellan gum, agar-agar, and carboxymethylcellulose, and wherein the total fat content lies between 0.05 and 15% by weight.

### CROSS-REFERENCE TO RELATED APPLICATIONS

This application is a continuation of International Patent Application No. PCT/EP2022/067678 filed Jun. 28, 2022, which application claims priority to European Patent Application No. 21181209.0 filed Jun. 29, 2021, the contents of which are both incorporated herein by reference in their entireties.

### FIELD OF THE INVENTION

The invention relates to a process for the production of a long-life, high-protein, fermented dairy product and to the long-life, high-protein, fermented dairy product obtainable by such process.

### BACKGROUND TO THE INVENTION

Acidified dairy products such as (ambient) yoghurts and quark offer good nutrition as they are rich in vitamins and minerals and provide high quality protein. As there tends to be a general focus on healthier, higher-protein diets in recent years, high-protein dairy products are currently in trend. Moreover, high-protein dairy products have been developed for people who need a higher doses of good quality proteins in their diets, such as older adults from 50 years onwards, or people who suffer from an illness, convalescing from surgery or anti-cancer therapy, are malnourished, frail elderly people, and people with sarcopenia. Furthermore, such products can be beneficial and useful to athletes. High-protein dairy products support muscle preservation and, as a result, healthy aging. Furthermore, they prevent muscle loss especially during immobilization and hospitalization, prior to surgery and during recovery afterwards.

Ambient products have the advantage that they are convenient for on-the-go so that the consumers can enjoy them whenever they want. However, the pasteurization required for obtaining long-life acidified products typically results in products which have an undesired texture and/or in an off-taste of the products. More particularly, the heat treatment of such a product, especially if sterilized after acidification/fermentation, leads to protein precipitation and an undesirable grainy texture. This effect is even more pronounced in case of higher protein levels.

There is therefore a need for acidified, high-protein, dairy products with good taste and mouthfeel and which do not have to be cooled for transportation and storage.

The objective underlying the present invention is to provide such an ambient stable, long-life, high-protein, dairy product having good taste and mouthfeel.

### SUMMARY OF THE INVENTION

It was found that the aforesaid objective could be met by producing a long-life, high protein, fermented dairy product according to a process comprising the steps of:
(a) homogenizing a milk base comprising microparticulated whey protein and two or more stabilizers selected from the group consisting of starch, gelatin, low-ester amidated pectin, guar, gellan gum, agar-agar and carboxymethylcellulose, resulting in a homogenized milk base,
(b) subjecting the homogenized milk base to a heat-treatment at a temperature of between 85-98° C., preferably between 90-97° C., and most preferably between 91-96° C., with a holding time of between 3-8 minutes, preferably 4-6 minutes, and most preferably 5 minutes,
(c) fermenting the homogenized and heat-treated milk base using a starter culture of lactic acid bacteria, resulting in a fermented milk product;
(d) subjecting the fermented milk product to a thermisation step at a temperature of between 75 and 82° C., resulting in a thermised milk product, and
(e) subjecting the thermised milk product to a cooling step, resulting in the long-life, high-protein, fermented dairy product.

By carrying out this process, a long-life, high-protein, fermented dairy product is obtained having good taste and particularly good mouthfeel.

Said long-life, high-protein, fermented dairy product comprises
a total amount of protein of between 6 and 24% by weight, based on the total weight of said product, with
   a total amount of micellar casein in the range of 15 and 40% w/w, based on the total amount of protein, and
   a total amount of 25 and 75% w/w, preferably between 35 and 65% w/w, of microparticulated whey protein, based on the total amount of protein,
between 0.3 and 4% by weight, based on the total weight of the product, of two or more stabilizers selected from the group consisting of starch, gelatin, low-ester amidated pectin, guar, gellan gum, agar-agar, and carboxymethylcellulose,
and
wherein the total fat content lies between 0.1 and 15% by weight, based on the total weight of the product.

### DETAILED DESCRIPTION OF THE INVENTION

Accordingly, in a first aspect the invention relates to a long-life, high-protein, fermented dairy product comprising
a total amount of protein of between 6 and 24% by weight, based on the total weight of the product, with
   a total amount of micellar casein in the range of 15 and 40% w/w, based on the total amount of protein, and
   a total amount of 25 and 75% w/w, preferably between 35 and 65% w/w, of microparticulated whey protein, based on the total amount of protein,
between 0.3 and 4% by weight, based on the total weight of the product, of two or more stabilizers selected from the group consisting of starch, gelatin, low-ester amidated pectin, guar, gellan gum, agar-agar, and carboxymethylcellulose,
and
wherein the total fat content lies between 0.1 and 15% by weight, based on the total weight of the product.

WO2015/059248 pertains to a new type of denatured whey protein compositions having a low content of soluble whey protein and a high content of protein, to a method of producing them and to products containing the high protein denatured whey protein compositions, particularly high protein, acidified dairy products, and additional uses thereof.

WO2015/059245 pertains to a new type of high protein denatured whey protein compositions having a low content of soluble alpha-lactalbumin and to a method of producing them. It furthermore pertains to products containing the high protein denatured whey protein compositions, particularly high protein, acidified dairy products, and additional uses thereof.

These documents, however, do not relate to long-life high-protein, fermented dairy products.

CN111248271 relates to a composition that can be used to prepare yoghurt, which comprises raw milk, sweetening substances, whey protein powder, modified starch, and high ester pectin, gellan gum, emulsifier and starter. The proportion of each component in the composition is as follows: raw milk not less than 80%, sweet substances 70‰-95‰, whey protein powder 37‰-50‰, acid-resistant high-ester pectin 4‰-6‰, modified starch does not exceed 10‰, gellan gum 0.1‰-0.4‰, emulsifier 0.5‰-2.0‰, starter 50DCU-100DCU/‰; wherein the whey protein powder is low-viscosity and heat-stable WPC80. Such a composition, however, results in a product having a powdery, sandy, mouthfeel.

It was found that the specific combination and amounts of proteins and stabilizers as used according to the invention resulted in the surprisingly good sensory properties (in mouthfeel and taste) of the present long-life, high-protein, fermented dairy product.

The term “long-life food product” generally refers to a product that, either by its ingredients per se or by a special treatment, or both, is preservable, and can be stored for an extended period of time (e.g. two or more weeks, sometimes even several months) and possibly at ambient conditions, i.e. not refrigerated. This is also true for the long-life dairy products according to the present invention. More particularly, the long-life dairy products according to the present invention at least have a shelf life of 2 weeks when stored at 20° C.

The consistency of the product according to the present invention may vary from a drinkable liquid to a fresh cheese-like texture. Preferably, the product is a spoonable product.

The term “microparticulated whey protein” as used throughout this specification is meant to denote all whey proteins that have been subjected to a microparticulation step, i.e. a treatment wherein the whey proteins are first denatured and aggregated by heat treatment (i.e. are lumped together), whereafter the resulting aggregations are divided into smaller particles via mechanical processing. “Microparticulated whey protein” is also often referred to as “denatured whey protein”. The denatured whey protein will have another flavor and a different appearance from the original whey protein.

Both the process and the use of microparticulated whey proteins (MWP) was patented by Singer et al. in 1988 (EP0250623). Singer et al. disclosed a process wherein a WPC50 dispersion is heated at acidic pH (pH 3.5-5.0) together with an emulsifier in a specially designed scraped surface heat exchanger, resulting in soluble spherical whey protein particles in a size range from 0.1-3 μm.

WO2006/024395, for example, also discloses a microparticulation process wherein whey concentrate is heat treated (in a scrape heat exchanger) and thereafter subjected to a mechanical processing (in a homogenizer).

Such microparticulated whey protein has been used in dairy products such as cheese and yoghurt before. U.S. Pat. No. 5,096,731, for example, relates to a yoghurt formulated with microparticulated protein which serves as a replacement for all or part of the fat and/or oil normally found in yoghurt. The microparticulated protein comprises substantially non-aggregated particles of denatured protein having a mean diameter of 0.5-2 microns when in a dry state.

The long-life, high-protein, fermented dairy product according to the present invention preferably is yoghurt, skyr, fresh cheese, Greek style yoghurt, quark, labneh, and kefir. It is noted that in some countries, the wording “yoghurt”, “skyr”, and/or “fresh cheese” are reserved for products with specific requirements. For instance, in some countries it is not allowed to denote a long-life product as a yoghurt, as according to local regulation, a yoghurt requires the presence of living culture. Hence, the long-life, high-protein, fermented dairy product of the present invention can also be a yoghurt-type product, a skyr-type product, a fresh cheese-type product, or the like.

The total fat content of the product lies between 0.05 and 15% by weight, based on the total weight of the product. The fat in the long-life, high-protein, fermented dairy product may originate entirely from the milk base used, but additional fat (animal fats, vegetable fats or a combination thereof) may be used as well. The fat is preferably dairy fat. In one embodiment, the long-life, high-protein, fermented dairy product is a yoghurt comprising between 0.5 and 10% by weight of fat.

The total amount of protein in the long-life, high-protein, fermented dairy product according to the present invention is at least 6% by weight and at most 24% by weight, based on the total weight of said product. Between 15 and 40 wt %, preferably between 18 and 35 wt %, of the protein is micellar casein, whereas between 25 and 75 wt %, preferably between 35 and 65 wt %, of the protein is microparticulated whey protein (weight percentages based on total weight of the protein). Other proteins in the long-life, high-protein, fermented dairy product of the invention such as calcium caseinate and whey protein preferably may come from proteins which are naturally present in the milk base or may be added to the milk base (e.g. WPC80).

In another embodiment, the total amount of protein in the long-life, high-protein, fermented dairy product is at least 8% by weight. Preferably, the total amount of protein in said product is between 8.1 and 24% by weight, and most preferably between 8.5-20% by weight, based on the total weight of said product. Preferably, between 18 and 35 wt %, more preferably between 19 and 32 wt %, of the protein is micellar casein, whereas preferably between 35 and 65 wt % of the protein is microparticulated whey protein (weight percentages based on total weight of the protein).

Microparticulated whey protein suitable for use in the products of the invention is all types of microparticulated whey protein which is known to be suitable for use in food and drinks for human consumption. The microparticulated whey protein used in accordance with the invention typically has an average particle size which is small and typically has a low surface reactivity so that creaminess, smoothness is increased and graininess kept to a minimum or even prevented. More particularly, the microparticulated whey protein that is used in the product and process according to the present invention is preferably microparticulated protein that comprises substantially non-aggregated particles of denatured protein having a mean diameter of 0.1-3 microns when in a dry state, preferably having a mean diameter of 0.5-2 microns when in dry state. Preferred suppliers of the microparticulated whey protein suitable for use in accordance with the present invention are Arla (Nutrilac®) and Fonterra (SureProtein™) In another embodiment of the invention, the long-life, high-protein, fermented dairy product further comprises one or more additives selected from the group consisting of cereals, nuts, seeds, fruit pieces, fruit puree, fruit juice, juice concentrate, flavoring agents, coloring agents, sweeteners, emulsifiers and acidity regulators. The use of emulsifier(s) is especially favorable in case of products based on skimmed milk powder. Preferred emulsifiers are mono- and diglycerides of fatty acids (E471).

As described above, the long-life, high-protein, fermented dairy product is preferably a spoonable product. With the term “spoonable product” is meant that the product according to the present invention is a product which has a semi-solid form and which can be scooped up and consumed directly. More particularly, it means that said product preferably has a viscosity of at least 500 mPa·s, preferably at least 1.500 mPa·s and a viscosity of preferably at most 15.000 mPa·s, more preferably at most 12.500 mPa·s. The viscosity of the product according to the present invention is determined using the Anton Paar rheometer at 10° C. A four blade sharp edge vane (ST24.8-V/40) and a cup holder (CC27/D) was used as a measuring system. In addition, TEZ-150P was used as a measuring cell and the Peltier element was set at 10° C. The rheological analysis is performed after the product is set, and after 24 hours. Final viscosity is the viscosity at a constant shear rate of 51 s⁻¹ expressed in mPa·s after 60 s. If the thus measured viscosity is between 500 mPa·s and 15.000 mPa·s, preferably between 1.500 mPa·s and 15.000 mPa·s, and most preferably between 1.500 mPa·s. and 12.500 mPa·s, the product qualifies as spoonable product.

As described above, in accordance with the invention, two or more stabilizers are used in an amount of between 0.3 and 4% by weight (based on the total weight of the product), said stabilizers being selected from the group consisting of starch, gelatin, low-ester amidated pectin, guar, gellan gum, agar-agar, and carboxymethylcellulose. In a preferred embodiment of the invention, two or more stabilizers are used in an amount of between 0.3 and 4% by weight (based on the total weight of the product), with one of the stabilizers being starch, combined with one or more stabilizers selected from the group consisting of gelatin, low-ester amidated pectin, guar, gellan gum, agar-agar, and carboxymethylcellulose.

In the long-life, high-protein, fermented dairy product according to the invention, the stabilizer is preferably a combination of starch and a low-ester amidated pectin or a combination of starch and gelatin. It was found that in case such a combination of stabilizers is used, the result is a product with an even improved mouthfeel: smooth without sandiness or a watery mouthfeel.

Pectin is a constituent of all plants. It consists of a complex set of polysaccharides that are present in most primary cell walls and are particularly abundant in the non-woody parts of terrestrial plants. Pectin is a major component of the middle lamella, where it helps to bind cells together, but is also found in primary cell walls. The amount, structure, and chemical composition of pectin differs among plants, even within a plant over time, and in various parts of a plant. Its main component, however, is galacturonic acid, a sugar acid derived from galactose. In nature, around 80 percent of carboxyl groups of galacturonic acid are esterified with methanol. This proportion is decreased to a varying degree during pectin extraction. Pectins are classified as high- vs. low-methoxy pectins (short HM-pectins vs. LM-pectins), with more or less than half of all the galacturonic acid esterified. The non-esterified galacturonic acid units can be either free acids (carboxyl groups) or salts with sodium, potassium, or calcium. Amidated pectin is a modified form of pectin. Here, some of the galacturonic acid is converted with ammonia to carboxylic acid amide.

With the term “low-ester amidated pectin” as used throughout the specification is meant any pectin having
a degree of esterification of less than 40%, preferably less than 35%, and most preferably of between 20 and 30%;
a degree of free acids of 50% or more; and
a degree of amidation of at least 5%, preferably at least 10%, and most preferably of between 20 and 30%,
   based on the total number of carboxylic groups present in the pectin.

Most preferred is a low-ester amidated pectin having a degree of esterification of 25%, a degree of amidation of 25%, and a degree of free acids of 50%.

Starch is a polymeric carbohydrate consisting of numerous glucose units joined by glycosidic bonds called polymers. This polysaccharide is produced by most green plants as energy storage. The starch preferably used in accordance with the present invention is modified starch such as for example acetylated distarch adipate (E1422) or hydroxypropyl-distarch phosphate (E1442). Clean label starches (i.e. starches without an E-number) can be used as well. Examples of suitable starches include native starches; physically modified starches, e.g via heat-moisture treatment; and enzymatically treated starches.

Gelatin is a mixture of peptides and proteins produced by partial hydrolysis of collagen extracted from the skin, bones, and connective tissues of animals such as domesticated cattle, chicken, pigs, and fish. Any type of gelatin known by the skilled person to be suitable for use in dairy products could be used in the composition according to the present invention. In a preferred embodiment edible gelatin 240 Bloom is used. It is a translucent, colorless, flavorless substance derived from collagen mainly inside pig skin and cattle bones.

The two or more stabilizers according to the invention are used in a total amount of between 0.3 and 4% by weight. When starch is used as one of the stabilizers, it is preferably used in an amount of between 0.2 and 3.0, more preferably between 0.8 and 1.6% by weight, and most preferably in an amount of 1.2% by weight, based on the total weight of the fermented dairy product. When gelatin is used as one of the stabilizers, it is preferably used in an amount of between 0.1 and 2.5, more preferably between 0.15 and 1.0% by weight, and most preferably in an amount of 0.3% by weight, based on the total weight of the fermented dairy product. When low-ester amidated pectin is used as one of the stabilizers, it is preferably used in an amount of between 0.05 and 1.0, more preferably between 0.1 and 0.8% by weight, and most preferably in an amount of 0.15% by weight, based on the total weight of the fermented dairy product. When gellan gum is used as one of the stabilizers, it is preferably used in an amount of between 0.01 and 0.5, more preferably between 0.02 and 0.4% by weight, and most preferably in an amount of 0.03% by weight, based on the total weight of the fermented dairy product. When carboxymethylcellulose is used as one of the stabilizers, it is preferably used in an amount of between 0.01 and 1.0, more preferably between 0.05 and 0.8% by weight, and most preferably in an amount of 0.1% by weight, based on the total weight of the fermented dairy product. When agar-agar is used as one of the stabilizers, it is preferably used in an amount of between 0.01 and 1.0, more preferably between 0.05 and 0.8% by weight, and most preferably in an amount of 0.2% by weight, based on the total weight of the fermented dairy product.

Preferably, if a combination of starch and a gelatin is used, the starch is used in an amount which is 2-10, preferably 3-8, and most preferably about 5, times the amount of gelatin. Preferably, if a combination of starch and low-ester amidated pectin is used, the starch is used in an amount which is 2-16, preferably 7-13, most preferably about 10, times the amount of low-ester amidated pectin.

The present invention furthermore relates to a method of preparing a long-life, high protein, fermented dairy product comprising the steps of
(a) homogenizing a milk base comprising microparticulated whey protein and two or more stabilizers selected from the group consisting of starch, gelatin, low-ester amidated pectin, guar, gellan gum, agar-agar, and carboxymethylcellulose, resulting in a homogenized milk base;
(b) subjecting the homogenized milk base to a heat-treatment at a temperature of between 85-98° C., preferably between 91-96° C., with a holding time of between 3-8 minutes, preferably 4-6 minutes, most preferably 5 minutes;
(c) fermenting the homogenized and heat-treated milk base using a starter culture of lactic acid bacteria, resulting in a fermented milk product;
(d) subjecting the fermented milk product to a thermisation step at a temperature of between 75 and 82° C., resulting in a thermised milk product; and
(e) subjecting the thermised milk product to a cooling step,
   resulting in the long-life, high-protein, fermented dairy product.

The milk base that is used in step (a) can be any type of cow's milk conventionally used to prepare products such as yoghurt or quark. It can for example be raw cow's milk, sterilized or pasteurized cow's milk, or it can be a recombined milk base. The recombined milk base is for example skimmed milk powder dissolved in water.

The milk base which is used in step (a) comprises between 0.05 and 15% by weight, more preferably between 0.1 and 12% by weight, and most preferably between 0.5 and 10% by weight, of fat. To this milk base, the microparticulated whey protein is add in the appropriate amount. More particularly, protein is added in such an amount that the milk base comprises a total amount of protein of between 6 and 24% by weight, based on the total weight of the milk base, and with a total amount of micellar casein being in the range of 15 and 40% by weight, preferably between 18 and 37% by weight, based on the total amount of protein, and a total amount of microparticulated whey protein being in the range of between 25 and 75% by weight, preferably between 35 and 65% by weight, based on the total amount of protein. Preferably, however, protein is added to the milk base in such an amount that the milk base comprises a total amount of protein of at least 8% by weight and at most 24% by weight, more preferably of between 8.1 and 22% by weight, and most preferably of between 8.5 and 20% by weight, based on the total weight of the product, while the total amount of micellar casein being in the range of 15 and 40% by weight, preferably between 18 and 37% by weight, based on the total amount of protein, and a total amount of microparticulated whey protein being in the range of between 25 and 75% by weight, preferably between 35 and 65% by weight, based on the total amount of protein.

The homogenization step (a) is performed in order to minimize or even prevent creaming of the milk base, which would be undesired. This homogenization step can be conducted using conventional techniques. Preferably, however, the homogenization step is performed at a pressure of at least 120 bar, preferably between 120 and 250 bar, most preferably between 170 and 190 bar.

The heat-treatment (step (b)) is performed to denature at least 95%, preferably at least 97%, and most preferably 100%, of the whey protein in the milk base and to deactivates enzymes and bacteria, especially pathogens, present in the milk base as much as possible. This step is performed at a temperature of between 85 and 98° C., preferably between 91 and 96° C., and most preferably 95° C., using a holding time of between 3 and 8 minutes, preferably between 4 and 6 minutes, most preferably 5 minutes. is recommended to denature the whey protein of the milk at least >95%-100%.

In step (c), the homogenized and heat-treated milk base is subjected to a fermenting step using a suitable starter culture of lactic acid bacteria, in the conventional amount. Any Starter culture traditionally used in making yoghurt, yoghurt-type, skyr, skyr-type, fresh cheese, fresh cheese-type, Greek style yoghurt, labneh, kefir, or other fermented dairy products may be used. The starter cultures are either mixtures of lactic acid bacteria or single strains. Commercial starter cultures comprising lactic acid bacterial species are preferably selected from the group consisting of Lactobacillus, Leuconostoc, Lactococcus, and Streptococcus.

As the skilled person will understand, the starter culture and the temperature that needs to be applied depends on the type of product to be produced. In case the long-life, high protein, fermented dairy product is a yoghurt or yoghurt-type product, St. thermophilus and Lb. bulgaricus are typically used. Other lactic acid bacteria that can be used are for example Lb. acidophilus or Bifibacterium bifidum.

In step (d), the fermented milk product is subjected to a thermisation step, which is performed at a temperature of between 75 and 82° C., preferably, between 77 and 80° C., with a holding time of preferably at least 15 seconds, and more preferably at least 30 seconds and preferably of at most 300 seconds, more preferably at most 250 seconds. Conventional equipment used for similar treatments can be used for this treatment. The thermisation step is preferably carried out gently, i.e. the temperature difference ΔT in the heat exchanger between product and heating medium is as low as possible.

In step (e), the thermised milk product is subjected to a cooling step. Said cooling step can be performed using techniques known in the art.

The process according to the present invention results in a long-life, high-protein, fermented dairy product. As described above, with the term “long-life” is meant that the product is shelf-stable for at least 2 weeks at a temperature of 20° C. The products according to the present invention typically have a shelf life of at least 3 weeks when stored at 20° C.

It is possible to add in a step in-between fermenting step (c) and thermisation step (d), one or more additives selected from the group consisting of cereals, nuts, seeds, fruit pieces, fruit puree, fruit juice, juice concentrate, flavoring agents, coloring agents, sweeteners, emulsifiers, and acidity regulators are added to the fermented milk product. Such additives can also be added, albeit in an aseptic manner, to the long-life, high-protein, fermented dairy product obtained in step (e) of the present process. If such additives are used, they are preferably used in a total amount of between 4.5 and 15% by weight, based on the total weight of the fermented dairy product.

In case flavoring agents, coloring agents, sweeteners and/or acidity regulators are used, it is possible to add such additives already to the milk base that is subjected to the homogenization step (a).

In one embodiment according to the invention, a smoothening step is performed in-between step (c) and step (d) of the above-described process. The fermented milk product obtained in step (c) may comprise larger gel particles (i.e. particles with a particle size of >10 μm). Such particles may cause a sandy mouthfeel in the final product. This smoothening step has the advantage that any larger gel particles that may exist, will be made smaller or even destroyed so that a homogeneous yoghurt mass is obtained and the final product has an improved mouthfeel. This smoothening step can be performed using conventional techniques known to the skilled person. If one or more additives are to be added, said additive is preferably added after said smoothening step.

In another embodiment according to the present invention, the long-life, high-protein, fermented dairy product according to the present invention is packaged, preferably via aseptic filling of a package. Said package is preferably a can, a carton, or a plastic box.

The long-life, high-protein, fermented dairy product of the invention, and especially the product wherein the total amount of protein is at least 8% by weight and at most 24% by weight, preferably between 8.1 and 22% by weight, most preferably between 8.5 and 20% by weight, has many benefits. For example, such a product helps to support muscle protein synthesis, muscle building, growth, maintenance, preservation of muscle mass, strength and function. As such, it is especially suitable for use in an active lifestyle, to increase physical performance, for example in athletes, but also in elderly persons with an active lifestyle. Furthermore, the product is particularly suitable for use in prevention, mitigation, and/or (dietary) management of decline of lean body mass (int. al. due to aging), muscle decline, sarcopenia, frailty, muscle wasting and bond decline, fractures, immobilization, hospitalization, surgery and diseases. As the product according to the invention also helps to support blood glucose management (glycemic control), it is also particularly suitable for use in people with disturbed glycose/insulin metabolism and/or (pre)diabetes and in people with overweight or obesity. Thus, in another aspect, the present invention relates to the long-life, high-protein, fermented dairy product of the invention wherein the total amount of protein is at least 8% by weight and at most 22% by weight, preferably between 8.1 and 22% by weight, and most preferably between 8.5 and 20% by weight based on the total weight of the product, for use in providing nutrition to a person. Preferably, it relates to such a long-life, high-protein, fermented dairy product for use in providing nutrition to a person, wherein said person is an adult of the age of 50 or more, a person that is in a disease state, a person that is recovering from a disease state, a person that is malnourished, a sportsman, or an active adults of the age of 50 or more.

The invention is further exemplified by the following, non-limiting Examples:

### EXAMPLES

### Example 1

The following long-life, high protein fermented dairy products samples were prepared (Products 1-4).

Product 1 was prepared from the following ingredients:
Cow's Milk (semi-skimmed, 1.5% fat)
Caseinate (Excellion™ Calcium Caseinate, FrieslandCampina)
WPC (Progel 800, FrieslandCampina)
WPC microparticulated (Fonterra SureProtein™)
Starch (E1442)
Gelatin (240 Bloom)
Starter Culture (Lactic acid bacteria)
   Product 2 was prepared from:
Cow's Milk (semi-skimmed, 1.5% fat)
Caseinate (Excellion™ Calcium Caseinate, FrieslandCampina)
WPC (Progel 800, FrieslandCampina)
WPC microparticulated (Fonterra SureProtein™)
Starch (E1442)
Low-ester amidated pectin (Grinsted, IFF/DuPont)
Starter culture (Lactic acid bacteria)
   Product 3 was prepared from:
Water
Skimmed milk powder (FrieslandCampina)
Anhydrous milk fat (AMF, FrieslandCampina)
Caseinate (Excellion™ Calcium Caseinate, FrieslandCampina)
WPC (Progel 800, FrieslandCampina)
WPC microparticulated (Fonterra SureProtein™)
Starch (E1442)
Gelatin (240 Bloom)
Starter culture (Lactic acid bacteria)
   Product 4 was prepared from:
Water
Skimmed milk powder (FrieslandCampina)
Anhydrous milk fat (AMF, FrieslandCampina)
Caseinate (Excellion™ Calcium Caseinate, FrieslandCampina)
WPC (Progel 800, FrieslandCampina)
WPC microparticulated (Fonterra SureProtein™)
Starch (E1442)
Low ester-amidated pectin (Grinsted, IFF/DuPont)
Starter culture (Lactic acid bacteria)
   Table 1 shows the exact composition of Products 1-4.

TABLE 1

| | | Product 1 | Product 2 | Product 3 | Product 4 |
|---|---|---|---|---|---|
| | | (wt %) | (wt %) | (wt %) | (wt %) |
| Total Fat | Fat (wt %) | 1.5 | 1.5 | 1.5 | 1.5 |
| content | | | | | |
| Total Protein | Total Protein | 8 | 8 | 8 | 8 |
| content | content (wt %) | | | | |
| Starter culture | Starter culture of | | | | |
| | Lactic acid | | | | |
| | bacteria in | | | | |
| | appropriate | | | | |
| | amount | | | | |
| Milk base | Fresh Milk (semi- | 91.5 | 91.7 | | |
| Ingredients | skimmed) | | | | |
| | Skimmed milk | | | 8.7 | 8.7 |
| | powder | | | | |
| | Anhydrous milk | | | 0.97 | 0.97 |
| | fat | | | | |
| | Water | | | 81.8 | 81.9 |
| | Microparticulated | 6 | 6 | 6 | 6 |
| | whey protein | | | | |
| | (MWP 50) | | | | |
| | Caseinate | 0.5 | 0.5 | 0.5 | 0.5 |
| | (Preferable Ca | | | | |
| | Caseinate) | | | | |
| | WPC (preferable | 0.5 | 0.5 | 0.5 | 0.5 |
| | WPC 80) | | | | |
| | Modified starch | 1.2 | 1.2 | 1.2 | 1.2 |
| | E1442 | | | | |
| | Gelatin beef 240 | 0.3 | | 0.3 | |
| | Bloom | | | | |
| | Low-ester | | 0.15 | | 0.15 |
| | amidated pectin | | | | |
| | Emulsifier | | | 0.1 | 0.1 |
| | monoglyceride | | | | |
| | E471 | | | | |
| | | 100.00% | 100.00% | 100.00% | 100.00% |

The milk base ingredients together add up to 100% by weight. Table 1 further mentions the total fat content (in wt %, based on the total weight of the milk base), the total protein content (in wt %, also based on the total weight of the milk base), and the starter culture used. It is furthermore noted that the total amount of protein is the protein added as MWP, as WPC and as caseinate, and includes the protein coming from the cow's milk or skimmed milk powder.

### Preparation of Products 1-4:

All products were made by first premixing the dry ingredients. The dry premix was mixed into the liquid part (which was either cow's milk for Products 1 and 2 or water for Products 3 and 4) resulting in the respective milk bases. Next, for all milk bases, the following steps were performed:

The liquid milk base was heated to 55° C. and homogenized at 180 bar. The homogenized milk base was subsequently heat-treated at 95° C. for 5 minutes and finally cooled to fermentation temperature of 42° C. (thermophilic fermentation). The thus obtained homogenized and heat-treated milk base was mixed with a starter culture of lactic acid bacteria and the inoculated mixture was allowed to incubate at the fermentation temperature until a pH of 4.4 was reached. The fermented milk product was subjected to a smoothening step by stirring the product to break the gel and destroy gel particles, resulting in a homogeneous mixture. The smoothened fermented milk product was then cooled from 42 to 20° C. and subjected to a thermisation step at 76° C. for 10 sec followed by a cooling step to 20° C. Finally, the resulting high protein fermented dairy products were filled in an aseptic manner in plastic cups.

### Storage Sensory Test

The long-life, high protein fermented dairy Products 1-4 were subjected to sensory evaluations at different storage conditions. The sensory monitoring during the shelf life at 4 and 20° C. showed a good quality regardless of the high protein content, which was equal to long life yoghurt with a regular protein content (2-4%). More specifically, the texture of all 4 products was creamy, the mouthfeel was smooth. The products comprising gelatin as stabilizer were particularly preferred for their pleasant mouthfeel. The 4 products all scored well on taste. No sandiness was observed. The viscosity was equal to regular long life yoghurt.

### Example 2 and Comparative Example A

Product 5 according to the invention was compared to a comparative Product A wherein different types of stabilizers were used. More particularly, the composition of these products was as follows:

Product A was prepared from (see Table 2 for the exact composition):
Cow's Milk (semi-skimmed milk)
Caseinate (Excellion™ Calcium Caseinate, FrieslandCampina)
WPC (Progel 800, FrieslandCampina)
WPC microparticulated (Arla Nutrilac®
Starch (E1442)
High-esther Pectin (GENU® pectin, CP Kelco)
Starter Culture (Lactic acid bacteria)
   Product 5 was prepared from (see Table 2 for the exact composition):
Cow's Milk
Caseinate (Excellion™ Calcium Caseinate, FrieslandCampina)
WPC (Progel 800, FrieslandCampina)
WPC microparticulated (Arla Nutrilac®
Starch (E1442)
Low-ester amidated pectin (Grinsted, IFF/DuPont)
Starter culture (Lactic acid bacteria)

TABLE 2

| | | Product A | Product 5 |
|---|---|---|---|
| | | (wt %) | (wt %) |
| Total Fat | Fat % | 1.5 | 1.5 |
| content | | | |
| Total Protein | Protein Dosage | 8 | 8 |
| content | | | |
| Starter | Starter culture of Lactic acid | | |
| culture | bacteria in appropriate amount | | |
| Milk | Fresh Milk (semi-skimmed, 1.5% | 91.3 | 91.65 |
| Ingredients | fat) | | |
| | Microparticulated whey protein | 6 | 6 |
| | (MWP 50) | | |
| | Calcium Caseinate | 0.5 | 0.5 |
| | WPC 80 | 0.5 | 0.5 |
| Stabilizer | Modified starch E1422 | 1.2 | 1.2 |
| | High-ester pectin, E440i | 0.5 | |
| | Low-ester amidated pectin E440ii | | 0.15 |
| | | 100% | 100% |

The milk base ingredients together add up to 1000% by weight. Table 1 further mentions the total fat content (in wt %, based on the total weight of the milk base), the total protein content (in wt %, also based on the total weight of the milk base), and the starter culture used. It is furthermore noted that the total amount of protein is the protein added as MWP, as WPC and as caseinate, and includes the protein coming from the fresh cow's milk.

### Preparation of Product 5 and Product A:

Product 5 and Product A were prepared according to the same procedure as explained in detail for Products 1-4. It was found that Product 5 has a much smoother mouthfeel and a higher viscosity than Product A (Product 5 has about 50% higher viscosity than Product A). Both products have a smooth, homogeneous structure, but the mouthfeel of Product A is clearly powdery, sandy. The conclusion of the inventor is that the stabilization with amidated low-ester pectin is more efficient as it results in a much higher viscosity at lower dosage at Product 5 in comparison to sample A. It was surprisingly found that the mouthfeel of Product 5 is significantly smoother even with the higher viscosity.

### Comparative Example B

For this experiment, a product is made comparable to invention with 10% total protein content, wherein the microparticulated whey protein is exchanged with regular dairy proteins used for stabilization of stirred yoghurt, viz. sodium caseinate (Excellion™ EM 7 Calcium Caseinate, FrieslandCampina) and WPC80 (ex FrieslandCampina). The experiment results in a Product B which is highly viscous (nearly cuttable, not processable anymore with regular yoghurt processing equipment), and having a powdery and sandy mouthfeel. The viscosity is significantly higher than the maximum that is still acceptable for spoonable yoghurt (so higher than 15.000 mPa·s).

### Comparative Example C

For this experiment, a product comparable to the invention is produced with a total protein content of 10%, wherein only starch is used as a stabilizer. The experiment results in a product which shows a thinner and less jelly texture. The sample also shows a significant pronounced powdery, sandy mouthfeel.

### Example 3

The following long-life, high protein fermented dairy products samples were prepared (Products 6 and 7, see Table 3 for the exact composition). Product 6 was prepared from the following ingredients:
Cow's Milk (semi-skimmed, 1.5% fat)
Caseinate (Excellion™ Calcium Caseinate, FrieslandCampina)
WPC (Progel 800, FrieslandCampina)
WPC microparticulated (Fonterra SureProtein™)
Starch (E1442)
Gelatin (240 Bloom)
Starter Culture (Lactic acid bacteria)
   Product 7 was prepared from:
Cow's Milk (semi-skimmed, 1.5% fat)
Caseinate (Excellion™ Calcium Caseinate, FrieslandCampina)
WPC (Progel 800, FrieslandCampina)
WPC microparticulated (Fonterra SureProtein™)
Starch (E1442)
Gelatin (240 Bloom)
Starter culture (Lactic acid bacteria)

TABLE 3

| | | Product 6 | Product 7 |
|---|---|---|---|
| | | in wt % | in wt % |
| Total Fat | Fat (wt %) | 1.5 | 1.5 |
| content | | | |
| Total | Total Protein content | 14.75 | 21.75 |
| Protein | (wt %) | | |
| content | | | |
| Starter | Starter culture of Lactic | | |
| culture | acid bacteria in | | |
| | appropriate amount | | |
| Milk base | Fresh Milk (semi- | 84.20 | 77.50 |
| Ingredients | skimmed) | | |
| | Microparticulated whey | 14.15 | 21.15 |
| | protein (MWP 50) | | |
| | Caseinate (Ca | 0.3 | 0.3 |
| | Caseinate) | | |
| | WPC 80 | 0.3 | 0.3 |
| | Modified starch E1442 | 0.8 | 0.5 |
| | Gelatin beef 240 Bloom | 0.25 | 0.25 |
| | | 100.00% | 100.00% |

The milk base ingredients together add up to 100% by weight. Table 3 further mentions the total fat content (in wt %, based on the total weight of the milk base), the total protein content (in wt %, also based on the total weight of the milk base), and the starter culture used. It is furthermore noted that the total amount of protein is the protein added as MWP, as WPC and as caseinate, and includes the protein coming from the cow's milk.

### Preparation of Products 6 and 7:

Both products were made by first premixing the dry ingredients. The dry premix was mixed into the liquid part (i.e. the cow's milk) resulting in the respective milk bases. Subsequently, the following steps were performed:

The liquid milk base was heated to 55° C. and homogenized at 180 bar. The homogenized milk base was subsequently heat-treated at 95° C. for 5 minutes and finally cooled to fermentation temperature of 42° C. (thermophilic fermentation). The thus obtained homogenized and heat-treated milk base was mixed with a starter culture of lactic acid bacteria and the inoculated mixture was allowed to incubate at the fermentation temperature until a pH of 4.4 was reached. The fermented milk product was subjected to a smoothening step by stirring the product to break the gel and destroy gel particles, resulting in a homogeneous mixture. The smoothened fermented milk product was then cooled from 42 to 20° C. and subjected to a thermisation step at 76° C. for 10 sec followed by a cooling step to 20° C. Finally, the resulting high protein fermented dairy products were filled in an aseptic manner in plastic cups.

### Storage Sensory Test

Products 6 and 7 were subjected to sensory evaluations at different storage conditions. The sensory monitoring during the shelf life at 4 and 20° C. showed a good quality regardless of the high protein content, which was equal to long life yoghurt with a regular protein content (2-4%). More specifically, the texture of both products was good. Both products scored acceptable on taste. No sandiness was observed, but a protein taste was noticeable. The viscosity of Product 6 was slightly higher as compared to regular long life yoghurt. The viscosity of Product 7 was as compared to regular quark. When mixed with a fruit puree, both products scored well on taste.

### Example 8

The following long-life, high protein fermented dairy products sample was prepared (Product 8), from the following ingredients (see Table 4):
Cow's Milk (semi-skimmed, 1.5% fat)
Caseinate (Excellion™ Calcium Caseinate, FrieslandCampina)
WPC (Progel 800, FrieslandCampina)
WPC microparticulated (Fonterra SureProtein™)
Starch (E1442)
Agar agar
Starter Culture (Lactic acid bacteria)

TABLE 4

| | | Product 8 |
|---|---|---|
| | | (wt %) |
| Total Fat content | Fat (wt %) | 1.5 |
| Total Protein | Total Protein content (wt %) | 8 |
| content | | |
| Starter culture | Starter culture of Lactic acid bacteria | |
| | in appropriate amount | |
| Milk base | Fresh Milk (semi-skimmed) | 91.80% |
| Ingredients | Microparticulated whey protein (MWP | 6.00% |
| | 50) | |
| | Caseinate (Preferable Ca Caseinate) | 0.30% |
| | WPC (preferable WPC 80) | 0.30% |
| | Modified starch E1442 | 1.20% |
| | Agar Agar | 0.4% |
| | | 100.00% |

### Preparation of Product 8:

Product 8 was prepared in the same manner as Products 6 and 7.

### Storage Sensory Test

The long-life, high protein fermented dairy Product 8 was subjected to sensory evaluations at different storage conditions. The sensory monitoring during the shelf life at 4 and 20° C. showed a good quality, which was equal to long life yoghurt with a regular protein content (2-4%). More specifically, the texture of the product was good. Furthermore, the product scored acceptable on taste.

1. A high-protein, fermented dairy product, comprising:
(a) a total amount of protein of between 6 and 24% by weight, based on the total weight of the product, comprising:
(i) a total amount of micellar casein in the range of 15 and 40% w/w, based on the total amount of protein, and
(ii) a total amount of microparticulated whey protein in the range of 25 and 75% w/w, based on the total amount of protein,
(b) between 0.3 and 4% by weight of two or more stabilizers selected from the group consisting of starch, gelatin, low-ester amidated pectin, guar, gellan gum, agar-agar, and carboxymethylcellulose, and
wherein the total fat content is between 0.05 and 15% by weight.

2. The high-protein, fermented dairy product according to claim 2, wherein the a total amount of microparticulated whey protein is between 35 and 65% w/w, based on the total amount of protein.

3. The high-protein, fermented dairy product according to claim 1, wherein the total amount of protein is between 8-24% by weight, based on the total weight of the product.

4. The high-protein, fermented dairy product according to claim 1, wherein the fermented dairy product is a yoghurt or yoghurt type of product, skyr or a skyr type product, a fresh cheese or a fresh cheese type of product, labneh, Greek style yoghurt, kefir, or quark.

5. The high-protein, fermented dairy product according to claim 1, comprising a combination of starch and low-ester amidated pectin or a combination of starch and gelatin as stabilizers.

6. The high-protein, fermented dairy product according to claim 1, wherein the microparticulated whey protein has a mean diameter of 0.1-3 microns when in a dry state.

7. The high-protein, fermented dairy product according to claim 1, further comprising one or more additives selected from the group consisting of cereals, nuts, seeds, fruit pieces, fruit puree, fruit juice, juice concentrate, flavoring agents, coloring agents, sweeteners, emulsifiers, and acidity regulators.

8. The high-protein, fermented dairy product according to claim 1, having a viscosity of between 500 and 15.000 mPa·s.

9. The high-protein, fermented dairy product according to claim 8, having a viscosity between 1.500 mPa·s and 15.000 mPa·s.

10. A method of preparing a long-life, high protein, fermented dairy product comprising:
(a) homogenizing a milk base comprising microparticulated whey protein and two or more stabilizers selected from the group consisting of starch, gelatin, low-ester amidated pectin, guar, gellan gum, agar-agar and carboxymethylcellulose, resulting in a homogenized milk base;
(b) subjecting the homogenized milk base to a heat-treatment at a temperature of between 85-98° C. with a holding time of between 3-8 minutes;
(c) fermenting the homogenized and heat-treated milk base using a starter culture of lactic acid bacteria, resulting in a fermented milk product;
(d) subjecting the fermented milk product to a thermisation step at a temperature of between 75 and 82° C., resulting in a thermised milk product; and
(e) subjecting the thermised milk product to a cooling step, resulting in the long-life, high-protein, fermented dairy product.

11. The method according to claim 10, wherein the heat-treatment is at a temperature of between 91-96° C. with a holding time of between 4-6 minutes.

12. The method according to claim 10, further comprising adding to the fermented milk product, in-between (c) and (d), one or more additives selected from the group consisting of cereals, nuts, seeds, fruit pieces, fruit puree, fruit juice, juice concentrate, flavoring agents, coloring agents, sweeteners, emulsifiers, and acidity regulators.

13. The method according to claim 10, further comprising smoothening in-between (c) and (d).

14. The method according to claim 10, further comprising packaging the fermented dairy product via aseptic filling of a package.

15. A method of providing nutrition to a person in need thereof, comprising administering to the person a fermented diary product according to claim 1.

16. The method according to claim 15, wherein the person is an adult of the age of 50 or more, a person that is in a disease state, a person that is recovering from a disease state, a person that is malnourished, a sportsman, or an active adult of the age of 50 or more.
